(19) United States
(12) Patent Application Publication
(10) Pub. No.: US 2010/0084334 A1
(43) Pub. Date: Apr. 8, 2010

(54) METHOD FOR THE PRODUCTION OF A FILTER ELEMENT AND FILTER ELEMENT PRODUCED ACCORDING TO SAID METHOD

(76) Inventors: Giuseppe Galifi, Saarbrucken (DE); Harald Mees, Lebach (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/450,080

(22) PCT Filed: Dec. 6, 2007
(86) PCT No.: PCT/EP2007/010587

§ 371 Date: Sep. 10, 2009

(30) Foreign Application Priority Data
Mar. 20, 2007 (DE) 10 2007 013 178.1

(51) Int. Cl. B01D 29/11; B01D 29/21; B29C 65/16

(52) U.S. Cl. 210/497.01; 156/272.8; 156/90

(57) ABSTRACT

1. A method for the production of a filter element. 2. A method for the production of a filter element (1) comprising the steps: a) Providing a filter medium (3) surrounding an inner filter cavity (7) and comprising a heat-sealable material; b) Providing at least one end cap (9, 13) made of thermoplastic, laser-permeable material, forming a covering of the filter cavity (7) on at least one end; c) Forming a laser-impermeable barrier layer (31) between the end cap (9, 13) and the adjacent end of the filter medium (3) and d) Welding the end cap (9, 13) and filter medium (3) by irradiating laser-permeable material adjacent to the barrier layer (31) with laser energy such that, by heating the region adjacent to the barrier layer (31), a welding volume is provided as a joining element for the welded joint created by laser-transmission welding.

The invention relates in general to the production of filter elements, as are used in many fields of engineering for filtration of fluids of varied type, for example hydraulic fluids, lubricants, fuels and the like. Such filter elements are made preferably of metal-free components for reasons of efficient production, low weight, simple disposal and recycling, the fluid to be cleaned flowing from the inside to the outside through a filter medium which surrounds an inner filter cavity which forms the inlet side during filtration and the filter cavity being sealed on at least one end by an end cap which forms an enclosure for the bordering end.

The connection between the filter medium and wall region on the pertinent end cap must be made not only fluid-tight, but, additionally, a mechanically strong combination must be formed in order to ensure the structural strength of the filter element. Therefore complex joining methods are used in production, for example cementing the end edge of the filter medium into the enclosure on the end cap. As has been shown, these joining methods are time-consuming, so that the production costs are correspondingly high.

With respect to this problem, the object of the invention is to devise a method which enables especially efficient and economical production of filter elements. According to the invention this object is achieved by a method which has the features of claim 1 in its entirety.

With process steps a) to d) the invention makes it possible to produce the connection between the end cap and filter medium in an especially efficient manner by means of laser transmission welding. Although the laser permeability of the end cap when penetrated by laser light enables less absorption of the laser light and thus only little release of heat energy, and although the conventional filter media which are built up without metal are not suitable for absorbing laser light for producing welding energy, process step c) according to the invention ensures energy absorption in the immediate weld region by forming a laser-impermeable barrier layer between the end cap and the adjoining end of the filter medium. The melting material region which has been heated by laser light therefore forms the joining element for fusing the bordering joining partners and thus for welding the end cap and the filter medium.

The laser-impermeable barrier layer can be formed by a barrier layer being produced in the course of the production process when the end cap is injection molded by backspraying a film. Likewise the end of the filter medium in preparation for welding can be provided with a liquid which absorbs laser light and which forms the barrier layer.

In one especially advantageous embodiment of the method the procedure is, however, such that to form the barrier layer a laser-impermeable welding film is inserted between the end cap and bordering end of the filter medium.

In one especially advantageous embodiment of the method in which, before producing the welded joint, the filter medium made as a hollow cylinder is inserted into a support body which forms a fluid-permeable cylinder jacket, the method is executed such that the edge of the support body assigned to the end cap is also welded by laser transmission welding to the cap and the end region of the filter medium.

Likewise, a second laser-impermeable barrier layer, preferably a second welding film, can be inserted on the second end of the filter medium opposite the first end cap between the medium and an assigned second end cap and a welded joint can also be produced by laser transmission welding between the second end cap and the bordering filter element.

In an especially advantageous manner in this case the procedure can be such that the second end cap is also welded by means of laser transmission welding to the assigned end of the support body; this enables especially efficient production of the filter elements.

The material for the end caps and support bodies can be a laser-permeable thermoplastic, in particular polyamide.

The material of the welding film can likewise be polyamide, and a film thickness from 0.03 to 0.1 mm, preferably of 0.05 mm, can be used. With respect to the choice of the material of the end caps, welding film and filter medium, in any case the procedure is such that the welding film enables a connection of related plastic materials, and also those plastic materials which could not be directly welded to one another without the joining element which has been formed by the molten welding film.

The filter medium can advantageously be a ring body of a folded, multilayer filter mat length, for example, executed as is known from WO 2004/014516 A1.

The subject matter of the invention is also a filter element which is produced according to the method according to the invention and which has the features of claim 9 in its entirety.

The invention is detailed below using the exemplary embodiments shown in the drawings.

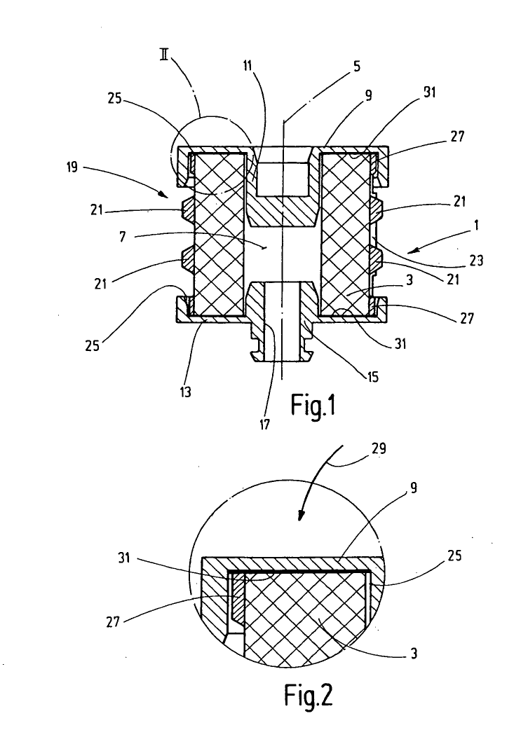

FIG. 1 shows a longitudinal section of one exemplary embodiment of a filter element produced according to the method claimed in the invention, shown approximately full scale;

FIG. 2 shows a sectional view of the region designated as II in FIG. 1, enlarged in comparison 5 times and

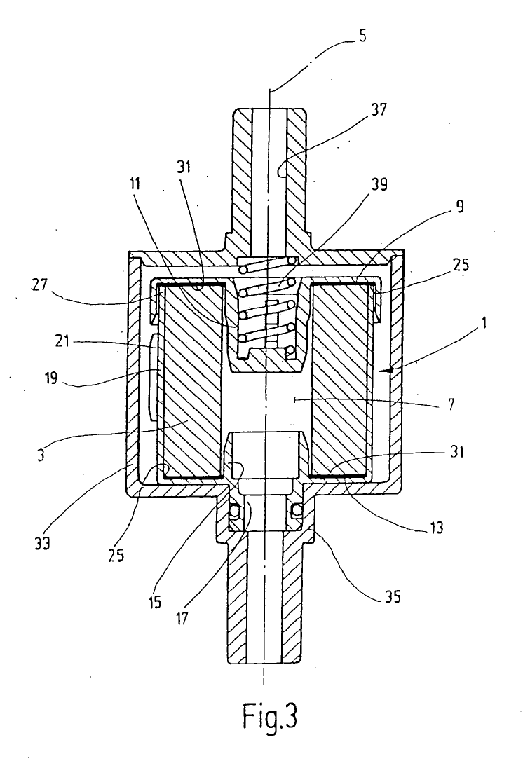

FIG. 3 shows a more or less full scale longitudinal section of a filter device in which a second exemplary embodiment of a filter element produced according to the process according to the invention has been installed.

The invention is explained below using one embodiment in which formation of the laser-impermeable barrier layer takes place such that the welding film detailed below is used as an insert part which is positioned prior to the welding process.

FIGS. 1 and 2 show a first embodiment of a filter element which is produced according to the method claimed in the invention and which is designated as a whole as 1. The main component is a filter medium formed from a filter mat which is made into a ring body 3 and which in the form of a hollow cylinder surrounds an inner filter cavity 7 concentrically to the longitudinal axis 5. The cavity is sealed on one end by a cover-side end cap 9 which is shaped in one piece from polyamide and has a central hollow peg 11 which is closed on the inner end and which extends along the inside of the ring body 3 into the filter cavity 7. On the opposite, bottom-side end the filter cavity 7 is bordered by a bottom-side end cap 13 which is likewise shaped in one piece from polyamide and has a central hollow peg 15 which similarly to the hollow peg 11 projects concentrically to the longitudinal axis 5 into the filter cavity 7. Differently than the hollow peg 11, the hollow peg 15 is continuously penetrated by a central inflow opening 17 by way of which a fluid to be cleaned flows into the filter cavity 7 in the filtration process.

The ring body 3 formed from the filter mat on its outside is supported on an adjoining polyamide support body 19 which forms a jacket body with ribs 21 between which there are fluid passages 23 through which cleaned fluid emerges after flowing through the ring body 3.

The end caps 9 and 13 each form an enclosure 25 for the ends of the ring body 3 and the end edges 27 of the support body 19. By means of laser transmission welding, laser light being emitted onto the laser-permeable end cap 9 (and likewise 13) as indicated in FIG. 2 with an arrow 29, a welded joint between the end of the ring body 3, the end edge 27 of the support body 19 and the bordering surface (radial plane to the longitudinal axis 5) of the enclosure 25 of the end caps is produced in one pass.

So that this is enabled in spite of the laser permeability of the end caps 9 and 11 and the ring body 3 which are not available for absorption of light energy, a laser-impermeable welding film 31 is inserted into the enclosure 25 such that it extends over the ends of the ring body 3 and the end edge 27 of the support body 19, adjoining the inside of the end caps 9 and 13 which runs in a radial plane. The circular ring-shaped welding film 31 is chosen such that it is impermeable to radiation in the wavelength range from 150 to 2500 nm, preferably from 500 to 1500 nm, i.e., it absorbs infrared or laser light, the film thickness being approximately between 0.03 to 0.1 mm, preferably about 0.05 mm. It can be a polyamide film with embedded laser-sensitive or infrared-sensitive particles, in particular color pigments such as carbon black or the like, these particles having a corresponding minimum temperature stability. In this connection, the procedure can be such that the ring-forming welding film 31 is irradiated with a pulsed laser or a continuous laser whose beam range is emitted beyond the ring region of the welding film 31 through the pertinent end caps 9 and 13 until the welding film 31 melts and fusion to the adjoining regions of the end caps 9, 13, of the end edges 27 of the support body 19 and the pertinent end of the ring body 3 of the filter medium occurs.

The filter medium which forms the ring body 3 can be provided as a filter mat length which is made, for example, with six layers and which in sequence has an outer support, a protective nonwoven, a prefilter layer, a main filter layer, a support nonwoven and an inner support. Since a polyamide lattice or a polyester fabric is possible for some of these layers, the filter medium can be hot-sealed, i.e., it is suitable for being welded as a joining partner by way of the welding film 31 which melts on to the end cap 9, 13 and the end edge 27 of the support body 19 as the other joining partners. In particular, the filter mat length is made pleated to increase the dirt absorption capacity and in this way is fixed with at least one free end side on the pertinent end cap. The melting zone on the free end side of the filter mat length, viewed in the axial longitudinal direction of the ring body 3, is dimensioned to be extremely small so that free flow through the filter medium is not adversely affected by the fixing process.

FIG. 3 shows one example of a filter element which has been modified compared to FIGS. 1 and 2, installed in a filter housing 33 which completes the filter device. The housing has a bottom-side fluid inlet 35 whose opening edge forms a receiver for the filter element 1 whose bottom-side hollow peg 15 sits in the opening of the inlet 35 with sealing. On the opposite end the filter housing 33 has a fluid outlet 37 for cleaned fluid, into the hollow peg 11 a compression spring 39 supported on the edge of the fluid outlet 37 extending into the upper hollow peg 11 which is closed on the inside end in order to press the filter element 1 into the element receiver on the inlet 35.

The sole difference of the filter element 1 of the example from FIG. 3 relative to the example from FIGS. 1 and 2 consists in that the lower end cap 13 which has the bottom-side hollow peg 15 is lengthened on the peripheral side beyond the enclosure 25 axially as far as the upper end cap 9 and that this extension forms the fluid-permeable support body 19 whose inside is adjoined by the ring body 3. As is the case for the support body 19 from FIGS. 1 and 2, its end edge 27 extends into the enclosure 25 on the upper end cap 9 so that in this embodiment by means of laser transmission welding using a welding film 31 the welded joint is produced between the ring body 3, the end edge 27 of the support body 19 and the end cap 9. Likewise, the welding of the lower end of the ring body 3 takes place using the welding film 31 which has been inserted on the lower end cap 13, that is, welding of the lower end of the ring body 3 to the lower end cap 13.

Instead of inserting a separate welding film, the end cap 9, 13 can also already be provided with a barrier layer. This barrier layer can be produced by backspraying with a suitable plastic material which forms the film, together with the production process of the end cap which can be conventionally produced by an injection molding process. Likewise, the free end or the free end region of the respective filter medium 3 before the actual transmission welding process can be provided with a barrier layer, for example, by applying a liquid which absorbs laser light. Here nanoparticulate fluids can also be used which have, for example, the corresponding graphite portions or the like. To the extent laser-impermeable barrier layers are discussed in this specification and in the claims, barrier layers reduced in terms of laser permeability are also addressed which therefore can partially transmit a certain portion of the laser light and still can absorb so much energy that the desired welded joint can be produced.

1. A method for the production of a filter element (1), with the following steps:
a) providing a filter medium (3) which surrounds an inner filter cavity (7) and contains a heat-sealable material;
b) providing at least one end cap (9, 13) with thermoplastic, laser-permeable material, which cap forms a covering of the filter cavity (7) on at least one end;
c) forming a laser-impermeable barrier layer (31) between the end cap (9, 13) and bordering end of the filter medium (3) and
d) welding the end cap (9, 13) and filter medium (3) by irradiating a laser-permeable material bordering the barrier layer (31) with laser energy such that by heating the region bordering the barrier layer (31) a welding volume is made available as a joining element for the welded joint produced by laser transmission welding.

2. The method according to claim 1, characterized in that to form the barrier layer a laser-impermeable welding film (31) is inserted between the end cap (9, 13) and the bordering end of the filter medium (3).

3. The method according to claim 1, characterized in that before producing the welded joint the filter medium (3) which is made as a hollow cylinder is inserted into a support body (19) which forms a fluid-permeable cylinder jacket and that the edge (27) of the support body (19) assigned to the end cap (9, 13) is also welded by laser transmission welding to the cap and the end region of the filter medium (3).

4. The method according to claim 1, characterized in that a second laser-impermeable barrier layer (31) is formed on the second end of the filter medium (3) opposite the first end cap (9) between the medium and an assigned second end cap (13) and a welded joint is also produced by laser transmission welding between the second end cap (13) and the bordering filter material (3).

5. The method according to claim 4, characterized in that the second end cap (13) is also welded by means of laser transmission welding to the assigned end (27) of the support body (19).

6. The method according to claim 3, characterized in that the material for the end caps (9, 13) and support bodies (19) is a thermoplastic, in particular polyamide, at least the material of the end caps (9, 13) being laser-permeable.

7. The method according to claim 2, characterized in that the material of the welding film (31) is polyamide in a thickness from 0.03 to 0.1 mm, preferably of 0.05 mm.

8. The method according to claim 1, characterized in that the filter medium is a ring body (3) of a folded, multilayer filter mat length.

9. A filter element (1) produced according to the method according to claim 1 with a filter medium (3) which surrounds the inner filter cavity (7) and at least one end cap (9, 13) which forms a covering of the filter cavity (7) on at least one end, the end cap being formed from a laser-permeable plastic material and being welded to the bordering end of the filter medium (3) by means of laser transmission welding.
